(19) United States
(12) Patent Application Publication
(10) Pub. No.: US 2022/0107412 A1
(43) Pub. Date: Apr. 7, 2022

(54) POSITION DETECTING DEVICE

(71) Applicant: TOYODA GOSEI CO., LTD., Kiyosu-shi (JP)

(72) Inventors: Ryusuke HORIBE, Kiyosu-shi (JP); Hiroshi YASUDA, Hirakata-shi (JP)

(21) Appl. No.: 17/484,573

(22) Filed: Sep. 24, 2021

(30) Foreign Application Priority Data
Oct. 1, 2020 (JP) 2020-167241

(51) Int. Cl. G01S 17/32; G01S 7/481; G01S 7/48

(52) U.S. Cl. CPC G01S 17/32; G01S 7/4808; G01S 7/4813

(57) ABSTRACT

A position detecting device includes light-emitting units, a light-receiving unit, a low-frequency cutoff unit, and a position detecting unit. The light-emitting units emit optical signals that are intensity-modulated using modulated signal streams. The light-receiving unit receives reflected light reflected by an object and converts the reflected light into an electric signal. The position detecting unit detects a position of the object based on the electric signal. An initial period or an intermediate period in a modulation period is defined as a first period. A period other than the first period is defined as a second period. The cutoff frequency in the first period is defined as a first cutoff frequency. The cutoff frequency in the second period is defined as a second cutoff frequency. The low-frequency cutoff unit is configured to cause the first cutoff frequency to be higher than the second cutoff frequency.

### BACKGROUND

### Field

The present disclosure relates to a position detecting device that detects the position of an object.

### Description of Related Art

Some position detecting devices, which detect the position of an object, are of an optical type (for example, Japanese Laid-Open Patent Publication No. 2011-215099).

The position detecting device disclosed in the publication includes light-emitting units, a light-receiving unit, and a position detecting unit (processing unit). The light-emitting units each emit an optical signal to an object. The light-receiving unit receives light reflected by the object and converts the received light into an electric signal. The position detecting unit (processing unit) detects the position of the object based on the electric signal. The device is configured such that the processing unit receives the electric signal via a low-frequency cutoff unit, which attenuates frequency components lower than a cutoff frequency.

When performing position detection, the position detecting device lights the light-emitting units sequentially and detects reflected light using the light-receiving unit. The received reflected light is input to the processing unit. Then, the position of the object is calculated (detected) based on the quantity of the detected reflected light, specifically, the electric signal input to the processing unit.

The low-frequency cutoff unit includes a high-pass filter circuit, which has a resistor and a capacitor. The resistor is biased by a specific voltage. Thus, the output signal changes in the following manner when the low-frequency cutoff unit receives a pulse stream. That is, the electric signal amplitude (specifically, its peak value and average), which is output from the low-frequency cutoff unit, changes from a specific bias voltage and temporarily reaches an amplitude that corresponds to the amplitude of the pulse stream, at the beginning of input of the pulse stream to the low-frequency cutoff unit. Thereafter, the amplitude gradually decreases in accordance with a time constant, which is defined by a resistance value R of the resistor and a capacitance C of the capacitor, so that the average of the pulse stream gradually approaches the specific bias voltage. If the signal duty cycle of the pulse stream is 50%, the signal amplitude between the maximum peak and the minimum peak within the entire time domain is 1.5 times greater than the input amplitude of the low-frequency cutoff unit.

In order to perform accurate position detection using the position detecting device, the signal-to-noise ratio (SNR) of the electric signal input to the processing unit needs to be maximized. That is, since the noise level is substantially constant in a normal system, the electric signal amplitude input to the processing unit needs to be maximized within the input dynamic range of the processing unit.

As described above, the device, which includes the low-frequency cutoff unit, temporarily increases the electric signal amplitude, which is output when a pulse stream is input to the low-frequency cutoff unit. Thus, in order to confine the electric signal within the input dynamic range of the processing unit in the subsequent stage, the amplitude of the input signal to the low-frequency cutoff unit must be reduced. As a result, the reduction in the signal amplitude reduces the signal-to-noise ratio (SNR). The input dynamic range of the processing unit thus cannot be used effectively.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a position detecting device is provided that includes light-emitting units, a light-receiving unit, a low-frequency cutoff unit, and a position detecting unit. The light-emitting units emit optical signals that are intensity-modulated using modulated signal streams of different phases. The light-receiving unit receives reflected light and converts the reflected light into an electric signal. The reflected light is the optical signal reflected by an object. The low-frequency cutoff unit attenuates a signal component in the electric signal that has a frequency lower than a cutoff frequency. The position detecting unit receives the electric signal that has been attenuated by the low-frequency cutoff unit, and detects a position of the object based on the electric signal. An initial period or an intermediate period in a modulation period, in which intensity-modulation is performed using the modulated signal stream, is defined as a first period. A period other than the first period is defined as a second period. The cutoff frequency in the first period is defined as a first cutoff frequency. The cutoff frequency in the second period is defined as a second cutoff frequency. The low-frequency cutoff unit is configured to cause the first cutoff frequency to be higher than the second cutoff frequency.

Other features and aspects will be apparent from the following detailed description, the drawings, and the claims.

### BRIEF DESCRIPTION OF THE DRAWINGS

FIG. 1 is a schematic diagram showing a distance detection mode of a position detecting device according to one embodiment.

FIG. 2 is an explanatory diagram illustrating manners in which detection is performed in the distance detection mode.

FIG. 3 is a schematic diagram showing a tilt angle detection mode of the position detecting device.

FIG. 4 is an explanatory diagram illustrating manners in which detection is performed in the tilt angle detection mode.

FIG. 5 is a schematic diagram showing a detection circuit of the position detecting device.

FIG. 6 is a timing diagram showing various signal waveforms in the detection circuit.

FIG. 7 is a simplified diagram of a circuit structure of a synchronous detection unit.

FIG. 8 is a timing diagram showing signal waveforms in a position detecting device according to a comparative example.

FIG. 9 is a timing diagram showing signal waveforms in the position detecting device according to the embodiment of FIG. 1.

FIG. 10 is a timing diagram showing signal waveforms in the position detecting device according to the embodiment of FIG. 1.

FIG. 11 is a circuit diagram of a low-frequency cutoff unit.

FIG. 12 is a graph showing a relationship of various frequencies.

FIG. 13 is a timing diagram showing signal waveforms in a position detecting device according to a comparative example.

FIG. 14 is a timing diagram showing signal waveforms in the position detecting device according to the embodiment of FIG. 1.

FIG. 15 is a graph showing a relationship of various frequencies according to a modification.

FIG. 16 is a timing diagram showing signal waveforms according to the modification of FIG. 15.

FIG. 17 is a timing diagram showing signal waveforms according to the modification of FIG. 15.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

A position detecting device according to one embodiment will now be described.

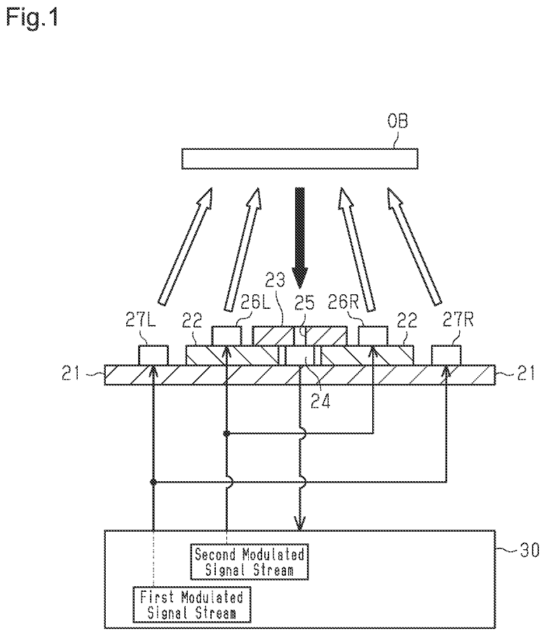

As shown in FIG. 1, the position detecting device of the present embodiment has a three-layer structure including a lower layer base 21, an intermediate layer base 22, and an upper layer base 23.

A light-receiving element 24 (a photodiode in the present embodiment) is provided on the lower layer base 21. The light-receiving element 24 detects the quantity of incident light. The light-receiving element 24 is located at the center of the lower layer base 21 on the side facing the intermediate layer base 22 (upper side as viewed in FIG. 1). The light-receiving element 24 is arranged in a gap between the lower layer base 21 and the upper layer base 23. The upper layer base 23 includes a through-hole (pinhole 25), which extends through the upper layer base 23 in a direction in which the bases are stacked (vertical direction as viewed in FIG. 1). The pinhole 25 is formed in a part that faces the light-receiving section of the light-receiving element 24. The position detecting device of the present embodiment has a structure in which external light is incident on the light receiving section of the light-receiving element 24 through the pinhole 25. In the present embodiment, the light-receiving element 24 corresponds to a light-receiving unit.

The position detecting device of the present embodiment includes four light-emitting elements 26L, 26R, 27L, 27R, which emit optical signals for position detection. In the present embodiment, the light-emitting elements 26L, 26R, 27L, 27R each include a light-emitting diode.

Two of the four light-emitting elements (inner light-emitting elements 26L, 26R) are provided on a surface of the intermediate layer base 22 that faces the upper layer base 23 (upper surface as viewed in FIG. 1). The upper layer base 23 is not provided in sections where the inner light-emitting elements 26L, 26R are provided. The inner light-emitting elements 26L, 26R are arranged so as to emit optical signals in a direction away from the intermediate layer base 22 (upward as viewed in FIG. 1).

The remaining two of the four light-emitting elements (outer light-emitting elements 27L, 27R) are provided on a surface of the lower layer base 21 that faces the intermediate layer base 22 (upper surface as viewed in FIG. 1). Neither the intermediate layer base 22 nor the upper layer base 23 is provided in sections where the outer light-emitting elements 27L, 27R are provided. The outer light-emitting elements 27L, 27R are arranged so as to emit optical signals in a direction away from the lower layer base 21 (upward as viewed in FIG. 1).

In the position detecting device of the present embodiment, the four light-emitting elements 26L, 26R, 27L, 27R and the light-receiving element 24 are arranged on a single straight line in a plan view (as viewed from the top in FIG. 1). Specifically, the inner light-emitting elements 26L, 26R are arranged on opposite sides of the light-receiving element 24, so as to be equally distanced from the light-receiving element 24. Also, the outer light-emitting elements 27L, 27R are arranged on opposite sides of the light-receiving element 24 and the inner light-emitting elements 26L, 26R, so as to be equally distanced from the light-receiving element 24. The outer light-emitting elements 27L, 27R are arranged on the outer sides of the inner light-emitting elements 26L, 26R in the direction which the four light-emitting elements 26L, 26R. 27L, 27R are arranged. In the position detecting device of the present embodiment, the distances between the inner light-emitting elements 26L, 26R and the light-receiving element 24 are shorter than the distances between the outer light-emitting elements 27L, 27R and the light-receiving element 24. In the present embodiment, the light-emitting elements 26L, 26R, 27L, 27R each correspond to a light-emitting unit.

The position detecting device of the present embodiment performs position detection of an object through synchronous detection.

The position detecting device of the present embodiment outputs, as drive signals for causing the light-emitting elements to blink, two types of modulated signal streams (a first modulated signal stream and a second modulated signal stream) of which the phases are displaced from each other by 90 degrees (specifically, a quarter of the wavelength). The first modulated signal stream and the second modulated signal stream are rectangular waves of a specific modulation frequency (40 kHz in the present embodiment).

When the position detecting device of the present embodiment performs position detection, a first light-emitting element LED1 is first driven by the first modulated signal stream to emit light. Then, after a phase delay of 90 degrees, a second light-emitting element LED2 is driven by the second modulated signal stream to emit light. Then, optical signals of the light-emitting elements LED1, LED2 (specifically, the quantity of light reflected by an object OB) are detected by the light-receiving element 24. Thereafter, the position of the object OB (specifically, the distance and the tilt angle) is detected based on the quantity of the reflected light detected by the light-receiving element 24.

The execution modes of the position detecting device includes a distance detection mode for detecting the distance to the object OB. The distance detection mode will now be described.

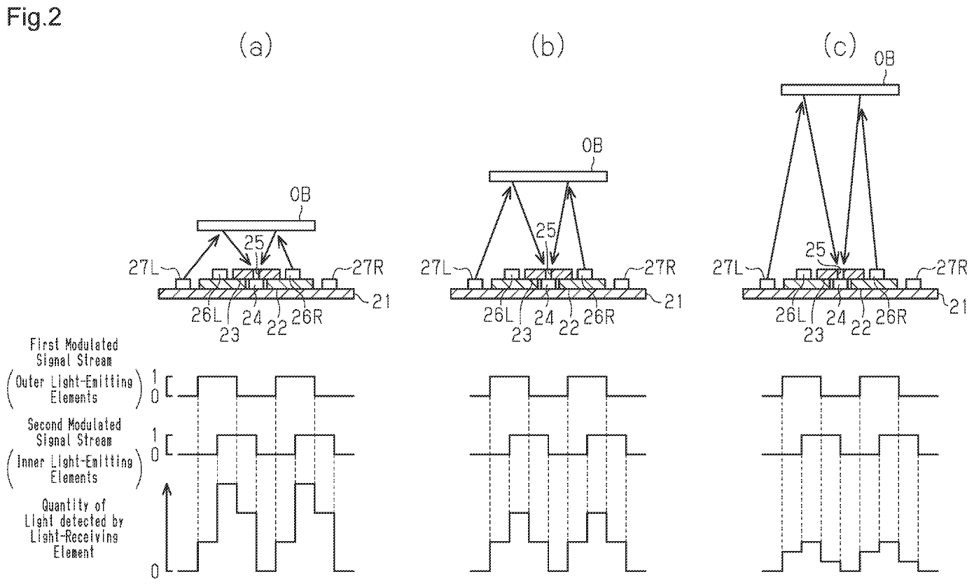

As shown in FIGS. 1 and 2, the distance detection mode uses the outer light-emitting elements 27L, 27R as the first light-emitting elements LED1, and uses the inner light-emitting elements 26L, 26R as the second light-emitting elements LED2. Specifically, the outer light-emitting elements 27L, 27R are driven by the first modulated signal stream to emit light, and the inner light-emitting elements 26L, 26R are driven by the second modulated signal stream to emit light. The distance detection mode is preferably configured such that the quantity of the optical signals emitted by the outer light-emitting elements 27L, 27R is greater than the quantity of the optical signals emitted by the inner light-emitting elements 26L. 26R. The ratio is set to, for example, 2:1.

When the distance to the object OB is relatively short as shown in section (a) of FIG. 2, the angle at which the optical signals of the outer light-emitting elements 27L, 27R (specifically, the light reflected by the object OB) is incident on the pinhole 25 (angle of incidence) is relatively large, and the optical path lengths are relatively long. Thus, the quantity of reflected light that is emitted by the outer light-emitting elements 27L, 27R and is incident on the light-receiving element 24, that is, a quantity VD1 of the reflected light detected by the light-receiving element 24 is relatively small. The inner light-emitting elements 26L, 26R are closer to the light-receiving element 24 than the outer light-emitting elements 27L, 27R. Thus, the angle of incidence on the pinhole 25 of the optical signals of the inner light-emitting elements 26L, 26R (specifically, light reflected by the object OB) is smaller than the angle of incidence of the optical signals of the outer light-emitting elements 27L, 27R. Also, the optical path lengths are relatively short. Thus, the quantity of reflected light that is emitted by the inner light-emitting elements 26L, 26R and is incident on the light-receiving element 24, that is, a quantity VD2 of the reflected light detected by the light-receiving element 24 is relatively large.

In the position detecting device of the present embodiment, the quantity of the optical signals of the outer light-emitting elements 27L, 27R is set to be twice the quantity of the optical signals of the inner light-emitting elements 26L, 26R. However, when the distance to the object OB is relatively short, a detected value (the light quantity VD2) related to the optical signals of the inner light-emitting elements 26L, 26R is greater than a detected value (the light quantity VD1) related to the optical signals of the outer light-emitting elements 27L, 27R. In this case, a ratio RD of the light quantities VD1 and VD2 (RD=VD1/VD2) is less than 1. The shorter the distance to the object OB, the smaller the value of the ratio RD becomes.

When the distance to the object OB is increased so as to be an intermediate distance as shown in section (b) of FIG. 2, the difference between the angle of incidence of the inner light-emitting elements 26L, 26R and the angle of incidence of the outer light-emitting elements 27L, 27R is reduced. This reduces the difference between the detected value (the light quantity VD2) related to the optical signals of the inner light-emitting elements 26L, 26R and the detected value (the light quantity VD1) related to the optical signals of the outer light-emitting elements 27L, 27R. In this case, the ratio RD of the light quantities VD1 and VD2 (RD=VD1/VD2) approaches 1. In the example shown in section (b) of FIG. 2, the light quantities VD1 and VD2 are equal to each other, and the ratio RD of the light quantities VD1 and VD2 (RD=VD1/VD2) is 1.

When the distance to the object OB is further increased as shown in section (c) of FIG. 2, the difference between the angle of incidence of the inner light-emitting elements 26L, 26R and the angle of incidence of the outer light-emitting elements 27L, 27R is substantially 0. Accordingly, the relationship between the light quantities VD1 and VD2 approaches the relationship between the quantity of the optical signals emitted by the outer light-emitting elements 27L, 27R and the quantity of the optical signals emitted by the inner light-emitting elements 26L, 26R. That is, in this case, the detected value (the light quantity VD1) related to the outer light-emitting elements 27L, 27R approaches a value twice the detected value (light quantity VD2) of the optical signals of the inner light-emitting elements 26L, 26R, and the ratio RD of the light quantities VD1 and VD2 (RD=VD1/VD2) approaches 2. In the example shown in section (c) of FIG. 2, the light quantity VD1 is twice the light quantity VD2, and the ratio RD of the light quantities VD1 and VD2 (RD=VD1/VD2) is 2.

In the distance detection mode, a distance DIS to the object OB is detected based on the above-described relationship between the light quantities VD1, VD2 and the distance to the object OB. Specifically, the light quantities VD1, VD2 are detected, and the distance to the object OB is calculated (detected) based on the ratio RD of the light quantities VD1 and VD2 (RD=VD1/VD2).

The execution modes of the position detecting device includes a tilt angle detection mode for detecting a tilt angle of the object OB. The tilt angle detection mode will now be described.

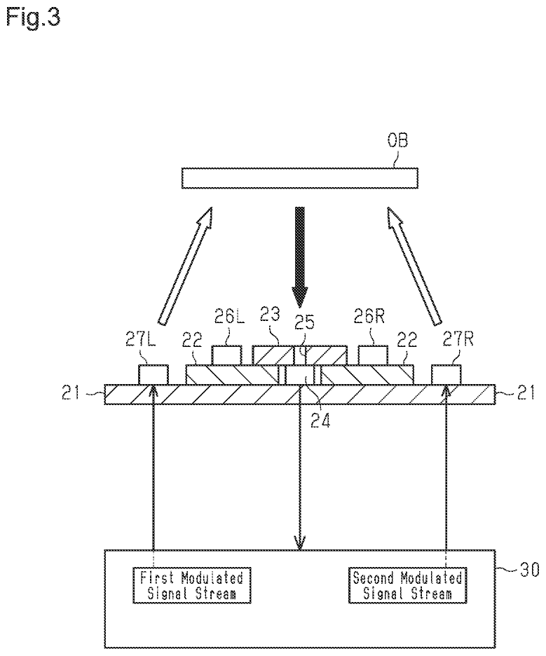

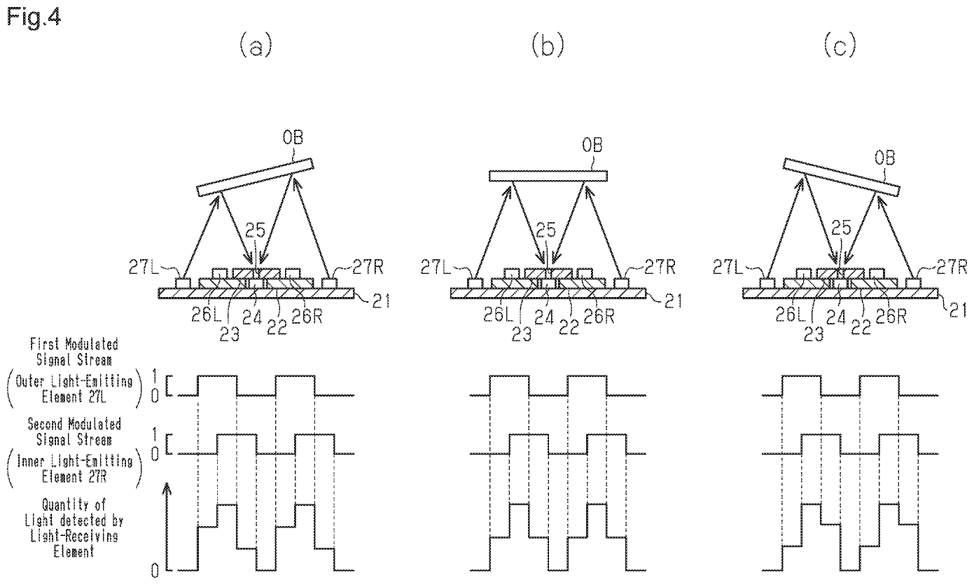

As shown in FIGS. 3 and 4, the tilt angle detection mode uses one of the outer light-emitting elements 27L, 27R (the outer light-emitting element 27L) as the first light-emitting element LED1, and uses the other one of the outer light-emitting elements 27L, 27R (the outer light-emitting element 27R) as the second light-emitting element LED2. Specifically, the outer light-emitting element 27L is driven by the first modulated signal stream to emit light. Then, after a phase delay of 90 degrees, the outer light-emitting element 27R is driven by the second modulated signal stream to emit light. In the tilt angle detection mode, the quantities of light emitted by the outer light-emitting elements 27L, 27R are set to be equal to each other.

When the object OB is inclined toward the outer light-emitting element 27L (to the left as viewed in FIG. 4) as shown in section (a) of FIG. 4, the distance between the outer light-emitting element 27L and the object OB is shorter than the distance between the outer light-emitting element 27R and the object OB. Accordingly, a path (optical path L1) of the light that is emitted by the outer light-emitting element 27L and is incident on the light-receiving element 24 is shorter than a path (optical path L2) of the light that is emitted by the outer light-emitting element 27R and is incident on the light-receiving element 24.

The quantity of the reflected light that is incident on the light-receiving element 24 is proportionate to the inverse square of the length of the optical path of the reflected light. Thus, as for the outer light-emitting element 27L, which has a relatively short optical path, a relatively large quantity of reflected light is detected by the light-receiving element 24. That is, a quantity VA1 of the light reflected by the object OB that is resultant of the optical signal emitted by the outer light-emitting element 27L is relatively large. In contrast, as for the outer light-emitting element 27R, which has a relatively long optical path, a relatively small quantity of reflected light is detected by the light-receiving element 24. That is, a quantity VA2 of the light reflected by the object OB that is resultant of the optical signal emitted by the outer light-emitting element 27R is relatively small.

Although the quantities of optical signals emitted by the outer light-emitting elements 27L and 27R are set to be equal to each other, the detected value (the light quantity VA1) related to the optical signal of the outer light-emitting element 27L is greater than the detected value (the light quantity VA2) related to the optical signal of the outer light-emitting element 27R. The ratio RA of the light quantities VA1 and VA2 (RA=VA1/VA2) is greater than 1 (RA>1). The larger the tilt angle of the object OB toward the outer light-emitting element 27L, the larger the value of the ratio RA becomes.

When the object OB faces the position detecting device squarely as shown in section (b) of FIG. 4 (tilt angle=0 degrees), the distances between the outer light-emitting elements 27L, 27R and the object OB are equalized. Thus, the path of the light that is emitted by the outer light-emitting element 27L and is incident on the light-receiving element 24 (optical path L1) is equal to the path of the light that is emitted by the outer light-emitting element 27R and is incident on the light-receiving element 24 (optical path L2). In this case, the detected value (the light quantity VA1) of the optical signal of the outer light-emitting element 27R is equal to the detected value (the light quantity VA2) of the optical signal of the outer light-emitting element 27R, and the ratio RA of the light quantities VA1 and VA2 (RA=VA/VA2) becomes 1.

When the object OB is inclined toward the outer light-emitting element 27R (to the right as viewed in FIG. 4) as shown in section (c) of FIG. 4, the distance between the outer light-emitting element 27L and the object OB is longer than the distance between the outer light-emitting element 27R and the object OB. Accordingly, a path (optical path L1) of the light that is emitted by the outer light-emitting element 27L and is incident on the light-receiving element 24 is longer than a path (optical path L2) of the light that is emitted by the outer light-emitting element 27R and is incident on the light-receiving element 24.

Thus, as for the outer light-emitting element 27L, which has a relatively long optical path, a relatively small quantity of reflected light is detected by the light-receiving element 24. That is, a quantity VA1 of the light reflected by the object OB that is resultant of the optical signal emitted by the outer light-emitting element 27L is relatively small. In contrast, as for the outer light-emitting element 27R, which has a relatively short optical path, a relatively large quantity of reflected light is detected by the light-receiving element 24. That is, a quantity VA2 of the light reflected by the object OB that is resultant of the optical signal emitted by the outer light-emitting element 27R is relatively large.

Although the quantities of optical signals emitted by the outer light-emitting elements 27L and 27R are set to be equal to each other, the detected value (the light quantity VA1) related to the optical signal of the outer light-emitting element 27L is less than the detected value (the light quantity VA2) related to the optical signal of the outer light-emitting element 27R. In this case, the ratio RA of the light quantities VA1 and VA2 (RA=VA1/VA2) is less than 1 (RA<1). The larger the tilt angle of the object OB toward the outer light-emitting element 27R, the smaller the value of the ratio RA becomes.

In the tilt angle detection mode, a tilt angle of the object OB is detected based on the above-described relationship between the light quantities VA1, VA2 and the tilt angle of the object OB. Specifically, the light quantities VA1, VA2 are detected, and a tilt angle TIL of the object OB is calculated (detected) based on the ratio RA of the light quantities VA1 and VA2 (RA=VD1/VD2). The relationship between the optical paths L1 and L2 changes in accordance with the distance between the object OB and the position detecting device. Thus, the ratio RA changes in accordance with the distance. Accordingly, when detecting the tilt angle TIL of the object OB, the position detecting device of the present embodiment uses the distance DIS as a detection parameter, in addition to the ratio RA.

Hereinbelow, a detection circuit 30 will be described that detects the quantities of light that is emitted by the light-emitting elements 26L, 26R, 27L, 27R and reflected by the object OB (specifically, the value V1, which corresponds to the light quantities VD1, VA1, and the value V2, which corresponds to the light quantities VD2. VA2).

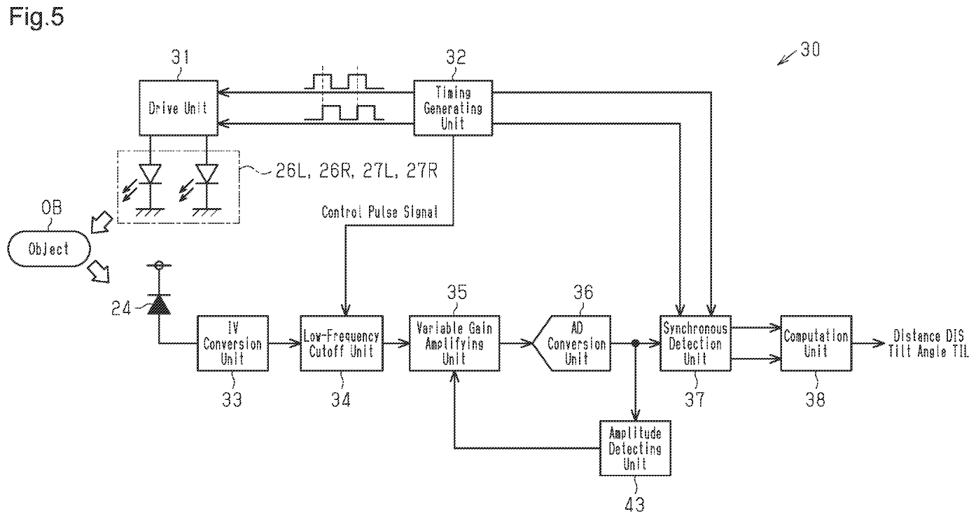

As shown in FIG. 5, the detection circuit 30 includes a configuration for emitting optical signals, which includes the light-emitting elements 26L, 26R, 27L, 27R, a drive unit 31, which drives the light-emitting elements 26L, 26R, 27L, 27R to emit light, and a timing generating unit 32, which generates the first modulated signal stream and the second modulated signal stream.

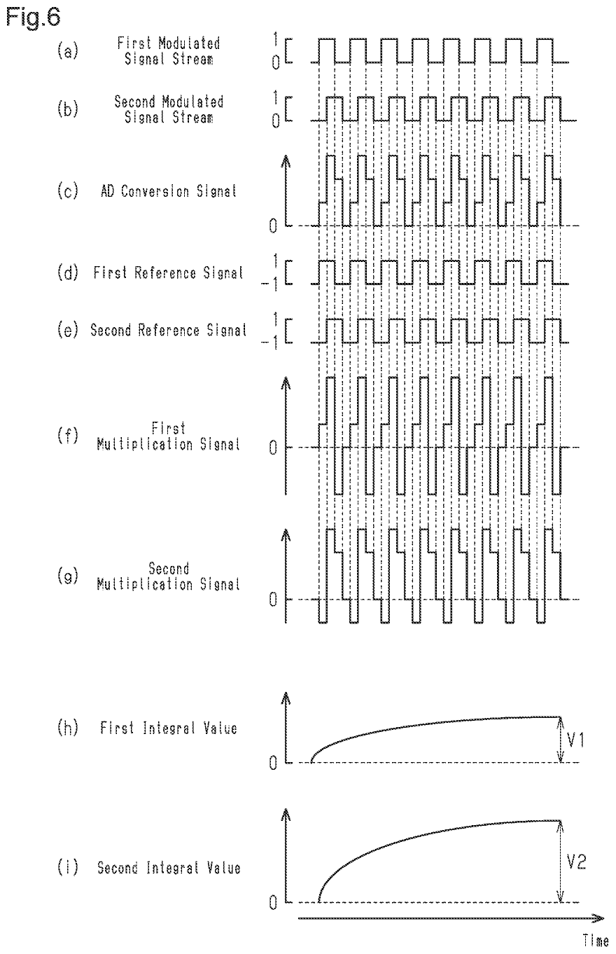

As shown in FIG. 6, the timing generating unit 32 generates two types of modulated signal streams including signals having rectangular waves over a specific amount of time. The phases of the modulated signal streams are displaced from each other by 90 degrees. The duty cycle of the modulated signal streams is 50%. The modulated signal streams include a first modulated signal stream (section (a) in FIG. 6)) and a second modulated signal stream (section (b) in FIG. 6).

As shown in FIG. 5, the timing generating unit 32 outputs the first modulated signal stream and the second modulated signal stream to the drive unit 31. The drive unit 31 selectively causes the light-emitting elements 26L. 26R, 27L, 27R to emit light based on the first modulated signal stream and the second modulated signal stream. In the distance detection mode, the inner light-emitting elements 26L, 26R are driven to emit light based on the first modulated signal stream, and the outer light-emitting elements 27L, 27R are driven to emit light based on the second modulated signal stream. In the tilt angle detection mode, the outer light-emitting element 27L is driven to emit light based on the first modulated signal stream, and the outer light-emitting element 27R is driven to emit light based on the second modulated signal stream.

The detection circuit 30 includes a configuration for detecting the quantity of the reflected light, which includes the light-receiving element 24, an IV conversion unit 33, a low-frequency cutoff unit 34, a variable gain amplifying unit 35, an AD conversion unit 36, a synchronous detection unit 37, and a computation unit 38, which are arranged in order from the light-receiving element 24. In the present embodiment, the variable gain amplifying unit 35, the AD conversion unit 36, the synchronous detection unit 37, and the computation unit 38 correspond to a position detecting unit.

The light-receiving element 24 is configured to output a current signal that corresponds to the quantity of reflected light that is incident on the light-receiving element 24.

The IV conversion unit 33 receives the current signal output from the light-receiving element 24. The IV conversion unit 33 converts the input current signal into a voltage signal and outputs the voltage signal.

The low-frequency cutoff unit 34 is a high-pass filter circuit that includes a buffer amplifier and a CR circuit having a capacitor and a resistor. The low-frequency cutoff unit 34 cuts off the DC component of the voltage signal output from the IV conversion unit 33, thereby preventing clipping of the signal in circuits at subsequent stages and allowing those circuits to operate with reference to a specific bias voltage. The low-frequency cutoff unit 34 receives the voltage signal (IV conversion signal) output from the IV conversion unit 33. The low-frequency cutoff unit 34 is configured to attenuate a signal component in the IV conversion signal that has a frequency lower than the cutoff frequency. In the present embodiment, the low-frequency cutoff unit 34 has a structure that is capable of changing the cutoff frequency. Control for changing the cutoff frequency will be described below. In the present embodiment, the above-described cutoff frequency is basically set to 1 kHz (basic cutoff frequency fb).

The variable gain amplifying unit 35 receives a voltage signal (a low-frequency cutoff signal) output from the low-frequency cutoff unit 34. The variable gain amplifying unit 35 is configured to change the amplification factor of an amplifier. The position detecting device of the present embodiment changes the gain of the variable gain amplifying unit 35 in order to adjust the amplitude of a voltage signal (variable gain signal) output from the variable gain amplifying unit 35 to an appropriate value. Control for variably setting the variable gain amplifying unit 35 will be described below.

The AD conversion unit 36 is configured to convert an analog signal into a digital signal. The AD conversion unit 36 receives the variable gain signal output from the variable gain amplifying unit 35. The AD conversion unit 36 converts the variable gain signal into a digital signal (16-bit signal (65536 steps) in the present embodiment) and outputs the digital signal.

As shown in section (c) in FIG. 6, the signal output from the AD conversion unit 36 (AD conversion signal) has a value obtained by superimposing the value V1 and the value V2. The value V1 corresponds to the quantity of the reflected light (the light quantities VD1. VA1) related to the optical signal emitted by the first light-emitting element LED1 based on the first modulated signal stream. The value V2 corresponds to the quantity of the reflected light (the light quantities VD2. VA2) related to the optical signal emitted by the second light-emitting element LED2 based on the second modulated signal stream.

A generally-used anti-aliasing filter may be provided at a stage prior to the AD conversion unit 36, in order to suppress the occurrence of aliasing during AD conversion.

The synchronous detection unit 37 includes a two-phase lock-in amplifier.

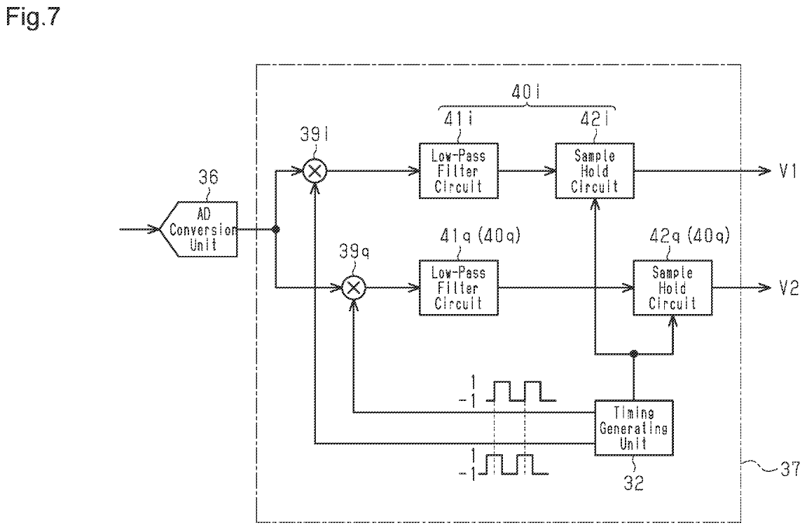

As shown in FIG. 7, the synchronous detection unit 37 includes multipliers 39i, 39q and integrators 40i, 40q. The multipliers 39i, 39q multiply a measurement signal (AD conversion signal) by a reference signal (the first modulated signal stream or the second modulated signal stream). The integrators 40i, 40q integrate a signal value output from the multipliers 39i, 39q (a first multiplication signal or a second multiplication signal). The integrators 40i, 40q include low-pass filter circuits 41i, 41q and sample hold circuits 42i, 42q.

The following describes the process through which the synchronous detection unit 37 calculates the value V1 corresponding to the quantity of reflected light (the light quantities VD1, VA1) related to the optical signal emitted by the first light-emitting element LED1 based on the first modulated signal stream. First, the multiplier 39i multiplies the AD conversion signal (section (c) in FIG. 6), which is a measurement signal, by the first modulated signal stream, which is a reference signal (specifically, a first reference signal shown in section (d) in FIG. 6). The first multiplication signal output from the multiplier 39i (section (f) in FIG. 6) is integrated by the integrator 40i as shown in section (h) in FIG. 6. The value integrated by the integrator 40i is output as the value V1.

The following describes the process through which the synchronous detection unit 37 calculates the value V2 corresponding to the quantity of the reflected light (the light quantities VD2, VA2) related to the optical signal emitted based on the second modulated signal stream. First, the multiplier 39q multiplies the AD conversion signal (section (c) in FIG. 6), which is a measurement signal, by the second modulated signal stream, which is a reference signal (specifically, a second reference signal shown in section (e) in FIG. 6). The second multiplication signal output from the multiplier 39q (section (g) in FIG. 6) is integrated by the integrator 40q as shown in section (i) in FIG. 6. The value integrated by the integrator 40q is output as the value V2.

The computation unit 38 calculates and outputs the distance DIS to the object OB through a computation process based on the values V1, V2, and calculates and outputs the tilt angle TIL of the object OB through a computation process based on the distance DIS and the values V1, V2. Specifically, the distance detection mode calculates the distance DIS to the object OB, from a relationship (for example, arithmetic expressions and operation tables) that is stored in the computation unit 38 in advance and based on the value V1 (the light quantity VD1) and the value V2 (the light quantity VD2). The tilt angle detection mode calculates the tilt angle TIL of the object OB, from a relationship (for example, arithmetic expressions and operation tables) that is stored in the computation unit 38 in advance and based on the value V1 (the light quantity VA1), the value V2 (the light quantity VA2), and the distance DIS. In the present embodiment, the synchronous detection unit 37 and the computation unit 38 each correspond to a digital signal processing unit, which performs a computation process on the digital signal converted by the AD conversion unit 36.

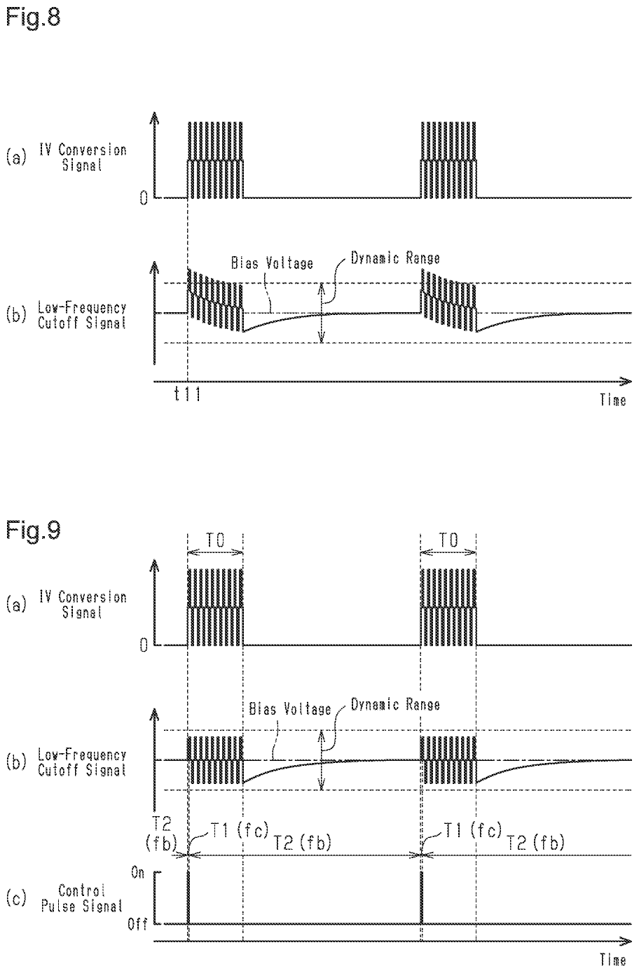

The low-frequency cutoff unit 34 includes a high-pass filter circuit, which has a CR circuit, in which the resistor is biased by a specific voltage. Thus, the low-frequency cutoff signal output from the low-frequency cutoff unit 34 changes in the following manner. That is, as described in an example in FIG. 8, the low-frequency cutoff signal (specifically, the peak value and the average) changes from a specific bias voltage and temporarily reaches an amplitude corresponding to the amplitude of the modulated signal at a point in time at which the modulated signal subjected to IV conversion is input to the low-frequency cutoff unit 34 (point in time t11). Thereafter, the amplitude gradually decreases in accordance with the time constant of the CR circuit, so that the average of the modulated signal gradually approaches the specific bias voltage.

If the signal duty cycle of a pulse stream is 50%, the signal amplitude between the maximum peak and the minimum peak within the entire time domain would be 1.5 times greater than the input amplitude of the low-frequency cutoff unit.

In order to allow the position detecting device to perform accurate position detection, it is necessary to maximize the signal-to-noise ratio (SNR) of the electric signal input to the AD conversion unit 36 (refer to FIG. 5). Since the quantization noise is substantially constant at AD conversion in a normal system, the electric signal amplitude input to the AD conversion unit 36 needs to be maximized within the input dynamic range of the AD conversion unit 36.

In this regard, in a device in which the amplitude of the low-frequency cutoff signal output from the low-frequency cutoff unit 34 is increased temporarily at the beginning of input of the modulated signal, the amplitude of the input signal must be reduced in order to confine the low-frequency cutoff signal (specifically, the electric signal input to the AD conversion unit 36) within the input dynamic range of the AD conversion unit 36. The reduced signal amplitude reduces the SNR, so that the input dynamic range of the AD conversion unit 36 cannot be used effectively.

Taking the above into consideration, the position detecting device of the present embodiment selectively switches the cutoff frequency of the low-frequency cutoff unit 34 between the basic cutoff frequency fb and a switching cutoff frequency fc. In the present embodiment, the switching cutoff frequency fc corresponds to a first cutoff frequency, and the basic cutoff frequency fb corresponds to a second cutoff frequency.

The following describes a configuration for switching the cutoff frequency of the low-frequency cutoff unit 34.

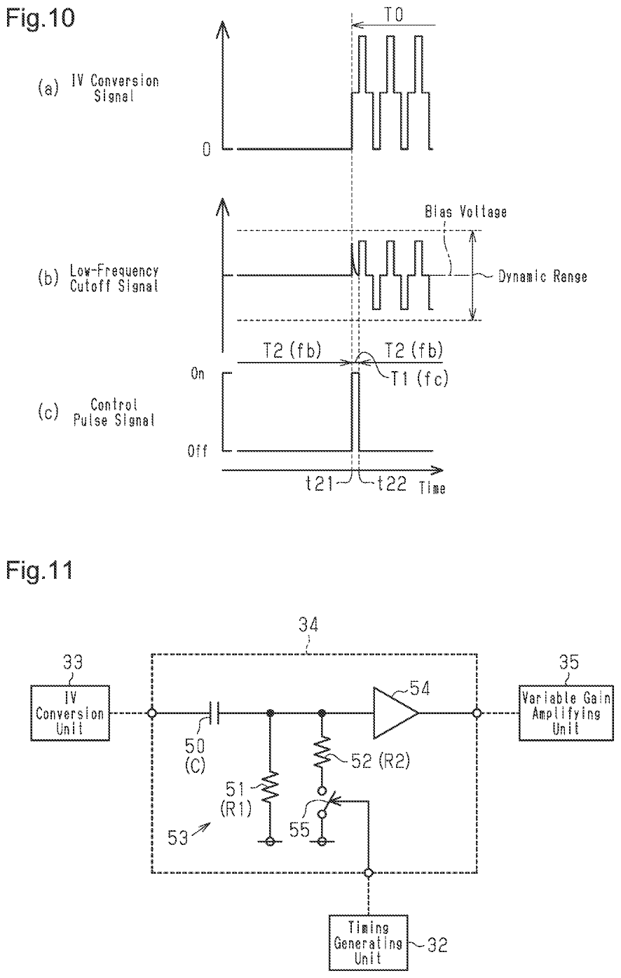

As shown in FIGS. 9 and 10, a period in which intensity modulation is performed using the first modulated signal stream and the second modulated signal stream is defined as a modulation period T0. An initial period of the modulation period T0 is defined as a first period T1, and the periods other than the first period T1 are defined as second periods T2.

In the position detecting device of the present embodiment, the operation of the low-frequency cutoff unit 34 is controlled to cause a cutoff frequency that is set in the first period T1 (the switching cutoff frequency fc [100 kHz in the present embodiment]) to be higher than a cutoff frequency that is defined in the second period T2 (the basic cutoff frequency fb [1 kHz in the position detecting device]).

Specifically, the first period T1 is a period from a point in time at which the modulation period T0 starts (a point in time t21 in FIG. 10) to a point in time in the first step-shaped pulse in the IV conversion signal (a point in time t22 in FIG. 10). Each step-shaped pulse represents a period in which the light-emitting element that is driven based on the first modulated signal stream emits, and in which the light-emitting element that is driven based on the second modulated signal stream does not emit light.

As shown in FIG. 11, the low-frequency cutoff unit 34 includes CR circuit 53, which includes a capacitor 50 and resistors 51, 52, and a buffer amplifier 54. The resistance of the low-frequency cutoff unit 34 is biased by the specific voltage. The resistor of the CR circuit 53 includes the two resistors 51, 52, which are connected in parallel. The resistor 52 is connected in series to a switch 55, which switches energization and de-energization of the resistor 52. The position detecting device of the present embodiment switches the cutoff frequency of the low-frequency cutoff unit 34 through operation of the switch 55.

Specifically, when the switch 55 is turned off, the resistor of the CR circuit 53 is formed by only the resistor 51. At this time, the time constant of the CR circuit 53 and thus the cutoff frequency of the low-frequency cutoff unit 34 are determined by the resistance value R1 of the resistor 51. In the present embodiment, the resistance value R1 of the resistor 51 is defined such that the cutoff frequency at this time is the basic cutoff frequency fb, which is relatively low.

When the switch 55 is turned on, the resistor of the CR circuit 53 is formed by the two resistors 51, 52, which are connected in parallel. At this time, the resistance value of the resistor of the CR circuit 53 is a combined resistance of the two resistors 51, 52 (R1×R2/(R1+R2)). The resistance value is thus less than the resistance value of the resistor of the CR circuit 53 with the switch 55 turned off (R1). This reduces the time constant of the CR circuit 53, so that the cutoff frequency of the low-frequency cutoff unit 34 is the switching cutoff frequency fc, which is relatively high. In the present embodiment, the resistance values R1, R2 of the resistors 51, 52 are defined such that the cutoff frequency of the low-frequency cutoff unit 34 at this time is the switching cutoff frequency fc, which is relatively high.

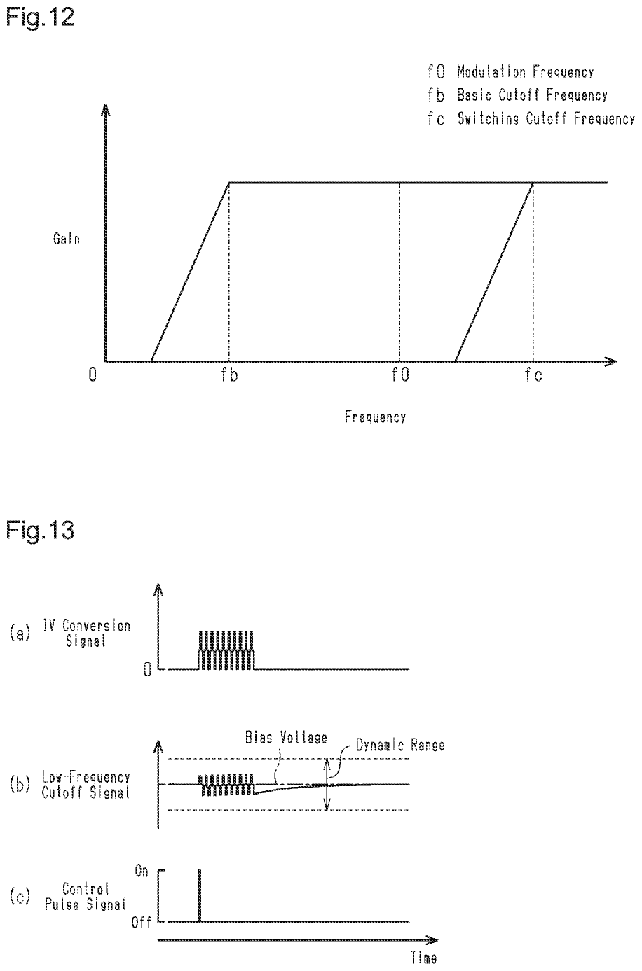

As shown in FIG. 12, in the position detecting device of the present embodiment, a modulation frequency M, the basic cutoff frequency fb, and the switching cutoff frequency fc are determined to satisfy the relational expression fb<f0<fc. In the present embodiment, in order to perform accurate position detection, the time constant of the CR circuit 53 at the time when the switch 55 is turned on is preferably less than or equal to a quarter of the time constant of the CR circuit 53 at the time when the switch 55 is turned off.

As shown in FIG. 5, the timing generating unit 32 of the position detecting device of the present embodiment outputs a control pulse signal for operating the switch 55 to the low-frequency cutoff unit 34. As shown in FIGS. 9 and 10, the control pulse signal includes an ON signal, which is output in the first period T1 to turn on the switch 55, and an OFF signal, which is output in the second period T2 to turn off the switch 55. In the present embodiment, the cutoff frequency of the low-frequency cutoff unit 34 is switched through operation of the switch 55 based on the control pulse signal.

Operational advantages achieved by switching the cutoff frequency of the low-frequency cutoff unit 34 will now be described.

As shown in FIGS. 9 and 10, during a period in which the electric signal that is output from the low-frequency cutoff unit 34 and input to the AD conversion unit 36 will not exceed the input dynamic range of the AD conversion unit 36 (second period T2), an OFF signal is output as the control pulse signal, and the basic cutoff frequency fb, which is relatively low, is employed. The basic cutoff frequency fb is sufficiently lower than the modulation frequency f1). Thus, during the second period T2, the low-frequency cutoff unit 34 does not attenuate a signal component corresponding to the quantity of the optical signal that is intensity-modulated using the first modulated signal stream and the second modulated signal stream (specifically, the reflected light), so that a signal component necessary for position detection is passed through the low-frequency cutoff unit 34 without distortion of the signal waveform due to missing signal component in terms of the frequency.

During a period in which the offset from the bias voltage of the electric signal output from the low-frequency cutoff unit 34 is increased transitionally (first period T1), an ON signal is output as the control pulse signal, so that the switching cutoff frequency fc, which is relatively high, is employed. This reduces the time constant of the CR circuit 53 (refer to FIG. 11) and thus quickly reduces the offset from the bias voltage of the low-frequency cutoff signal of which the signal amplitude is temporarily increased immediately after the beginning of input of the modulated signal, so that the low-frequency cutoff signal becomes close to the bias voltage. That is, the low-frequency cutoff signal readily becomes a value from which the temporary increase in the amplitude is eliminated.

In the present embodiment, the switching cutoff frequency fc is higher than the modulation frequency f0. This quickly attenuates a signal fluctuation component including a signal component of a frequency lower than the switching cutoff frequency fc, that is, a signal component that corresponds to the quantity of optical signal that is intensity-modulated using the first modulated signal stream and the second modulated signal stream (specifically, the reflected light of the optical signal). This allows the low-frequency cutoff signal output from the low-frequency cutoff unit 34 to quickly approach a value from which the temporary increase is eliminated.

In the present embodiment, the switching cutoff frequency fc (specifically, the capacitance C of the capacitor 50 and the resistance values R1, R2 of the resistors 51, 52) is determined based on various experiments and simulations performed by the inventors such that reduction in the offset from the bias voltage of the low-frequency cutoff signal is substantially completed during the first period T1.

The position detecting device of the present embodiment attenuates the offset of the low-frequency cutoff signal during the first period T1. This reduces the signal amplitude change from the bias voltage of the low-frequency cutoff signal output from the low-frequency cutoff unit 34 (specifically, the peak value and the average) in the second period T2, which is immediately after the first period T1. Thus, without reducing the amplitude of the low-frequency cutoff signal in advance in consideration of a section of the low-frequency cutoff signal that is increased temporarily, the maximum amplitude of the low-frequency cutoff signal can be confined within the input dynamic range after reducing the difference between the amplitude of the low-frequency cutoff signal input to the AD conversion unit 36 (specifically, the variable gain amplifying unit 35) and the input dynamic range of the AD conversion unit 36. In this manner, the position detecting device of the present embodiment uses the input dynamic range of the AD conversion unit 36 effectively to minimize the influence of quantization noise in the AD conversion unit and increase the SNR of the signal processing, thereby improving the accuracy of the position detection by the position detecting device.

In the present embodiment, the first period T1 is set to the initial period in the modulation period T0. Thus, the switching cutoff frequency fc can be set immediately after the beginning of input of the IV conversion signal to the low-frequency cutoff unit 34, so that the low-frequency cutoff signal output from the low-frequency cutoff unit 34 is attenuated at an early stage. This shortens the period in which the low-frequency cutoff signal output from the low-frequency cutoff unit 34 is increased temporarily immediately after the beginning of input of the IV conversion signal to the low-frequency cutoff unit 34.

As described above, there is a period during which the light-emitting elements that are driven based on the first modulated signal stream emit optical signals, and the light-emitting elements that are driven based on the second modulated signal stream do not emit optical signals. In other words, there is a period in which only part of the light-emitting units emit light. During this period, the offset from the bias voltage of the electric signal output from the low-frequency cutoff unit is quickly reduced. This allows the electric signal to fluctuate to increase and decrease from the bias voltage both at the time when all the light-emitting units are lit and at the time when all the light-emitting units are turned off. Accordingly, the electric signal is controlled to be confined within the input dynamic range of the position detecting unit efficiently.

In the position detecting device of the present embodiment, the current signal output from the light-receiving element 24, the IV conversion signal, and the low-frequency cutoff signal, are changed in accordance with the quantity of the reflected light that is incident on the light-receiving element 24. Therefore, if the AD conversion unit 36 performs signal conversion with a fixed gain, the following drawbacks may be caused. That is, as in an example illustrated in FIG. 13, when the quantity of reflected light that is incident on the light-receiving element 24 is small, the amplitude of the electric signal (the low-frequency cutoff signal in this example) input to the AD conversion unit 36 is small in relation to the input dynamic range of the AD conversion unit 36. In this case, the influence of the quantization noise of the AD conversion unit 36 reduces the SNR of the signal. This may reduce the accuracy of the position detection by the position detecting device.

Taking the above into consideration, the position detecting device of the present embodiment includes the variable gain amplifying unit 35 between the low-frequency cutoff unit 34 and the AD conversion unit 36 (FIG. 5). The variable gain amplifying unit 35 is controlled such that the amplitude of the electric signal input to the AD conversion unit 36 has a value within a predetermined specific range S (approximately 90% of the input dynamic range of the AD conversion unit 36 in the present embodiment).

The following describes a configuration for changing the gain of the variable gain amplifying unit 35.

As shown in FIG. 5, the detection circuit 30 includes an amplitude detecting unit 43, which detects an amplitude M of the AD conversion signal output from the AD conversion unit 36. The amplitude detecting unit 43 outputs the detected amplitude M of the AD conversion signal to the variable gain amplifying unit 35.

The amplitude detecting unit 43 detects the amplitude M of AD conversion signal in the following manner.

As shown in FIG. 6, in the modulation period T0, a signal value (MAX) of the AD conversion signal (MAX) when the light-emitting elements that are driven by the first modulated signal stream to emit light and the light-emitting elements that are driven by the second modulated signal stream to emit light are lit simultaneously corresponds to the maximum value of the signal value of the AD conversion signal. Also, in the modulation period T0, a signal value (MIN) of the AD conversion signal when the light-emitting elements that are driven by the first modulated signal stream to emit light and the light-emitting elements that are driven by the second modulated signal stream to emit light are turned off simultaneously corresponds to the minimum value of the signal value of the AD conversion signal.

Taking the above into consideration, the amplitude detecting unit 43 detects the signal value (MAX) of the AD conversion signal at the first simultaneous lighting in the modulation period T0, and the signal value (MIN) of the AD conversion signal at the first simultaneous turn-off in the period immediately before the modulation period T0 or in the modulation period T0. The amplitude detecting unit 43 then calculates a difference value (MAX−MIN) between the detected signal values as the amplitude M of the AD conversion signal, and executes a process that outputs the amplitude M to the variable gain amplifying unit 35.

The variable gain amplifying unit 35 calculates a control target value of the gain of the variable gain amplifying unit 35 based on the amplitude M of the AD conversion signal detected by the amplitude detecting unit 43 and the currently set gain of the variable gain amplifying unit 35. In the position detecting device of the present embodiment, the variable gain amplifying unit 35 stores in advance a relationship among a gain that causes the amplitude M of the AD conversion signal to fall within the specific range S of the dynamic range of the AD conversion unit 36 (control target value), the amplitude M of the AD conversion signal, and the gain of the variable gain amplifying unit 35. The variable gain amplifying unit 35 calculates the control target value based on the relationship. The variable gain amplifying unit 35 changes the gain such that the gain agrees with the control target value.

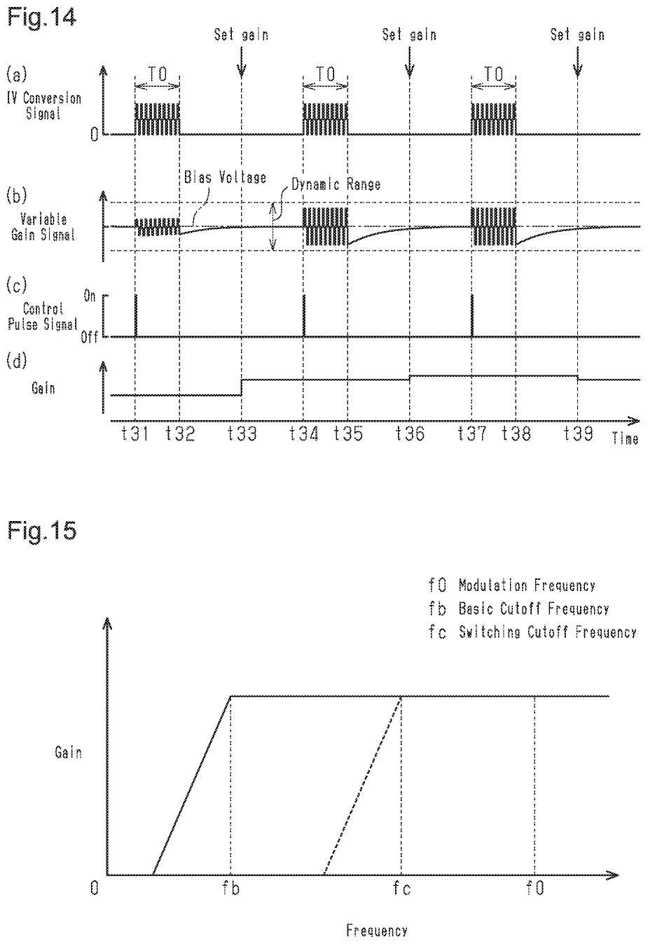

In the present embodiment, as shown in FIG. 14, points in time at which the gain of the variable gain amplifying unit 35 is changed (points in time t33, t36, t39) are set in a period in which neither the first modulated signal stream nor the second modulated signal stream is set, that is, a period from when the modulation period T0 ends to when the modulation period T0 is started.

Operational advantages achieved by changing the gain of the variable gain amplifying unit 35 will now be described.

In an example shown in FIG. 14, the amplitude of the IV conversion signal output from the IV conversion unit 33 during the first modulation period T0 (from the point in time t31 to the point in time t32) is relatively small, and the gain of the variable gain amplifying unit 35 is less than an appropriate value. Thus, the amplitude of the variable gain signal output from the variable gain amplifying unit 35 is small in relation to the input dynamic range of the AD conversion unit 36. In order to facilitate understanding, FIG. 14 illustrates a situation in which there are large differences in the IV conversion signal and the variable gain signal between the first modulation period T0 (from the point in time t31 to the point in time t32) and the immediately subsequent modulation period T0 (from a point in time t34 to a point in time t35). In the position detecting device of the present embodiment, the modulation period T0 is repeatedly set in short cycles. Thus, if position detection for the same object OB is performed continuously, the above-mentioned differences would be smaller than in the example shown in FIG. 14, and the values would change in a continuous manner.

The position detecting device of the present embodiment detects the amplitude M of the AD conversion signal (refer to section (c) in FIG. 6) in the modulation period T0 (from the point in time t31 to the point in time t32), and calculates the control target value related to the gain of the variable gain amplifying unit 35 based on the amplitude M.

The gain of the variable gain amplifying unit 35 is changed based on the control target value at specific point in time (point in time t33) after the modulation period T0 (from the point in time t31 to the point in time t32) and before the subsequent modulation period T0 (from the point in time t34 to the point in time t35). Accordingly, the gain of the variable gain amplifying unit 35 is changed to an appropriate value (a relatively large value in this example) prior to the subsequent input of the low-frequency cutoff signal to the variable gain amplifying unit 35. Thus, when the low-frequency cutoff signal is input to the variable gain amplifying unit 35 in the immediately subsequent modulation period T0 (from the point in time t34 to the point in time t35), the amplitude of the signal output from the variable gain amplifying unit 35, and thus the amplitude M of the AD conversion signal output from the AD conversion unit 36, fall within (or near) the predetermined specific range S.

The position detecting device of the present embodiment performs such control for changing the gain of the variable gain amplifying unit 35 each time the modulation period T0 is set at specific intervals (from the point in time t31 to the point in time t34, from the point in time t34 to the point in time t37, and after the point in time t37).

The position detecting device of the present embodiment changes the IV conversion signal and the low-frequency cutoff signal in accordance with the quantity of the reflected light that is incident on the light-receiving element 24. However, a change in the gain of the variable gain amplifying unit 35 does not cause the amplitude of the variable gain signal, which is input to the AD conversion unit 36, to exceed the input dynamic range of the AD conversion unit 36. Further, the variable gain signal is subjected to AD conversion effectively at an amplitude of approximately 90% of the input dynamic range of the AD conversion unit 36 (preferably, an amplitude of 60% to 90% of the input dynamic range). This minimizes the influence of the quantization noise in the AD conversion unit 36 and improves the SNR of the signal processing, allowing the position detecting device to perform accurate position detection.

As described above, the present embodiment provides the following advantages.

(1) The switching cutoff frequency fc, which is set in the first period T1, is higher than the basic cutoff frequency fb, which is set in the second period. This minimizes the change in the amplitude due to a transient response that has passed through the low-frequency cutoff unit 34. Also, since the input dynamic range of the AD conversion unit 36 is used effectively, it is possible to minimize the influence of quantization noise in the AD conversion unit 36 and increase the SNR of the signal processing, thereby improving the accuracy of the position detection by the position detecting device.

(2) The switching cutoff frequency fc, which is set in the first period T1, is higher than the modulation frequency M. This eliminates the amplitude change due to a transient response that has passed through the low-frequency cutoff unit 34, and allows the low-frequency cutoff signal output from the low-frequency cutoff unit 34 to quickly approach a value from which the temporary increase is eliminated.

(3) The first period T1 is set to an initial period in the modulation period T0. This shortens the period in which the low-frequency cutoff signal output from the low-frequency cutoff unit 34 is increased temporarily immediately after the beginning of input of the IV conversion signal to the low-frequency cutoff unit 34.

(4) The first period T1 is set to a period during which only part of the light-emitting units emit light. Thus, the offset from the bias voltage of the electric signal output from the low-frequency cutoff unit is quickly reduced. This allows the electric signal to fluctuate to increase and decrease from the bias voltage both at the time when all the light-emitting units are lit and at the time when all the light-emitting units are turned off. Accordingly, the electric signal is controlled to be confined within the input dynamic range of the position detecting unit efficiently.

(5) The gain of the variable gain amplifying unit 35 is controlled such that the amplitude of the electric signal input to the AD conversion unit 36 has a value within the predetermined specific range S. This minimizes the influence of quantization noise, allowing the position detecting device to perform accurate position detection.

(6) The difference value (MAX−MIN) between the signal value (MAX) of the AD conversion signal when the first light-emitting element LED1 and the second light-emitting element LED2 are simultaneously lit and the signal value (MIN) of the AD conversion signal when the first light-emitting element LED1 and the second light-emitting element LED2 are simultaneously turned off is detected as the amplitude M of the AD conversion signal. Therefore, the amplitude M of the AD conversion signal can be obtained from the electric signal at simultaneous lighting and the electric signal at simultaneous turn-off without providing a peak hold circuit or a bottom hold circuit that includes a time constant for detection. Also, when calculating the amplitude M, the signal value (MAX) of the AD conversion signal at the first simultaneous lighting in the modulation period T0 and the signal value (MIN) of the AD conversion signal at the first simultaneous turn-off in the modulation period T0 are detected and used. Thus, the amplitude M of the AD conversion signal is detected without delay in a short period immediately after the beginning of output of the AD conversion signal.

(7) The points in time at which the gain of the variable gain amplifying unit 35 is changed are set in a period from when the modulation period T0 ends to when the modulation period T0 is started. Thus, in the same modulation period T0, the gain of the variable gain amplifying unit 35 is maintained at a constant value without being changed. This prevents the occurrence of detection errors due to a change in the gain during the modulation period T0, allowing the position detecting device to perform accurate position detection.

The above-described embodiment may be modified as follows. The above-described embodiment and the following modifications can be combined as long as the combined modifications remain technically consistent with each other.

The position detecting device does not necessarily need to have a base of a three-layer structure. For example, the position detecting device may include a single layer structure in which the light-receiving element 24 is mounted on the lower surface (back surface) of the upper layer base 23, and light is received on the mounted surface of the light-receiving element 24. In this case, the light-receiving element 24 is preferably potted in a sealing material having a light shielding property, so as to avoid influence of stray light onto the back surface.

The variable gain amplifying unit 35 and the amplitude detecting unit 43 may be omitted, so that the low-frequency cutoff signal output from the low-frequency cutoff unit 34 is directly input to the AD conversion unit 36.

The method for calculating the amplitude M of the AD conversion signal can be changed. For example, it is possible to detect the signal value (MAX) of the AD conversion signal at simultaneous lighting during the modulation period T0, and the signal value (MIN) of the AD conversion signal at simultaneous turn-off during the modulation period T0 or at time other than the modulation period T0, and calculate the difference value between these signal values as the amplitude M of the AD conversion signal.

The point in time to change the gain of the variable gain amplifying unit 35 may be changed. For example, the gain of the variable gain amplifying unit 35 may be changed at a specific point in time in the modulation period T0.

The resistor 52 may be omitted while maintaining the switch 55 of the CR circuit 53. With this configuration, the resistance value of the resistor of the CR circuit 53 can be substantially reduced to 0 by turning on the switch 55. Thus, the cutoff frequency of the low-frequency cutoff unit 34 can be increased by turning on the switch 55 during the first period T1 to reduce the time constant of the CR circuit 53. This configuration is capable of causing the low-frequency cutoff signal, which is temporarily increased immediately after the beginning of input of the IV conversion signal to the low-frequency cutoff unit 34, to quickly approach a value from which the temporary increase is eliminated.

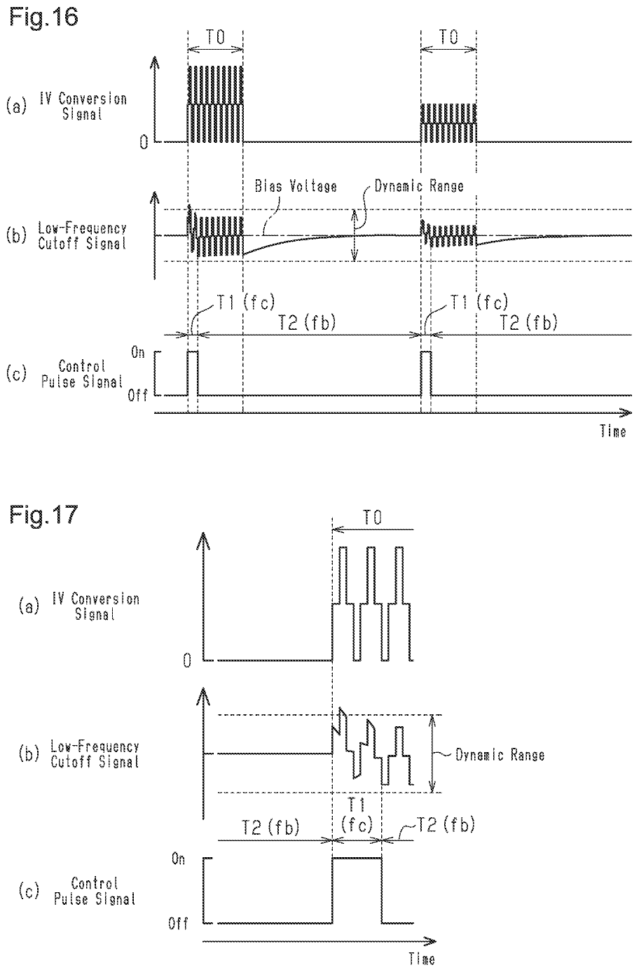

As shown in FIG. 15, the modulation frequency fb, the basic cutoff frequency fb, and the switching cutoff frequency fc may be determined to satisfy the expression fb<fc<f0. As shown in FIGS. 16 and 17, this configuration causes the cutoff frequency of the low-frequency cutoff unit 34 to become the switching cutoff frequency fc in the first period T1, so that the low-frequency cutoff signal, which is temporarily increased immediately after the beginning of input of the IV conversion signal to the low-frequency cutoff unit 34, is attenuated even though the attenuation speed is reduced.

The first period T1 may be changed as long as it is an initial period or an intermediate period in the modulation period T0. For example, the first period T1 may be a period that starts and ends in the middle of the first step-shaped pulse of the IV conversion signal. Alternatively, the first period T1 may include the first step-shaped pulse and the third step-shaped pulse of the IV conversion signal. Further, the first period T1 is preferably set to an initial period in the modulation period T0 in order to attenuate the low-frequency cutoff signal at an early stage so that accurate position detection can be performed.

The above-described embodiment may be applied to a position detecting device that includes multiple groups of light-emitting elements arranged on the same straight line. Such a position detecting device may have two groups of four light-emitting elements 26L, 26R, 27L, 27R, in which lines along which the light-emitting elements are arranged are orthogonal to each other.

The configuration according to the above-described embodiment may be applied to a position detecting device that outputs, as drive signals for driving light-emitting elements, two types of modulated signal streams (a first modulated signal stream and a second modulated signal stream) of which the phases are displaced from each other by an angle other than 90 degrees. Further, the configuration according to the above-described embodiment may be applied to a position detecting device that outputs two types of modulated signal streams (a first modulated signal stream and a second modulated signal stream), with which a state in which only the first light-emitting elements emit light and a state in which the second light-emitting elements emit light are repeated alternately.

The configuration according to the above-described embodiment is not limited to a position detecting device that detects both the position and the tilt angle of the object OB, but may be applied to a position detecting device that detects only one of the position and the tilt angle of the object OB.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A position detecting device, comprising:
light-emitting units that emit optical signals that are intensity-modulated using modulated signal streams of different phases;
a light-receiving unit that receives reflected light and converts the reflected light into an electric signal, the reflected light being the optical signal reflected by an object;
a low-frequency cutoff unit that attenuates a signal component in the electric signal that has a frequency lower than a cutoff frequency; and
a position detecting unit that receives the electric signal that has been attenuated by the low-frequency cutoff unit, and detects a position of the object based on the electric signal, wherein
an initial period or an intermediate period in a modulation period, in which intensity-modulation is performed using the modulated signal stream, is defined as a first period,
a period other than the first period is defined as a second period,
the cutoff frequency in the first period is defined as a first cutoff frequency,
the cutoff frequency in the second period is defined as a second cutoff frequency, and
the low-frequency cutoff unit is configured to cause the first cutoff frequency to be higher than the second cutoff frequency.

2. The position detecting device according to claim 1, wherein the first cutoff frequency is higher than a modulation frequency related to the intensity-modulation using the modulated signal stream.

3. The position detecting device according to claim 1, wherein the first period is set to the initial period in the modulation period.

4. The position detecting device according to claim 1, wherein the first period is set to a period in which only part of the light-emitting units emit light.

5. The position detecting device according to claim 1, wherein
the position detecting unit includes:
an AD conversion unit that converts an analog signal into a digital signal; and
a digital signal processing unit that performs a computation process on the digital signal converted by the AD conversion unit,
the position detecting device further comprises a variable gain amplifying unit that variably sets gain, the variable gain amplifying unit being provided between the low-frequency cutoff unit and the AD conversion unit, and
the position detecting device is configured to control the gain of the variable gain amplifying unit such that an amplitude of the electric signal input to the AD conversion unit has a value within a predetermined specific range.

6. The position detecting device according to claim 5, wherein the amplitude of the electric signal is a difference value between the electric signal when the light-emitting units are lit simultaneously and the electric signal when the light-emitting units are turned off simultaneously.

7. The position detecting device according to claim 5, wherein the variable gain amplifying unit changes the gain in a period in which the modulated signal stream is not provided.
